(19) United States
(12) Patent Application Publication
(10) Pub. No.: US 2016/0333851 A1
(43) Pub. Date: Nov. 17, 2016

(54) WIND POWER GENERATING APPARATUS

(71) Applicants: Nam-Kyu Choi, Guro-gu, Seoul (KR); Young-Hwa Choi, Guro-gu, Seoul (KR)

(72) Inventors: Nam-Kyu Choi, Guro-gu, Seoul (KR); Young-Hwa Choi, Guro-gu, Seoul (KR)

(21) Appl. No.: 15/110,365

(22) PCT Filed: Jan. 8, 2015
(86) PCT No.: PCT/KR2015/000173

§ 371 Date: Jul. 7, 2016

(30) Foreign Application Priority Data
Jan. 9, 2014 (KR) 10-2014-0002914

(51) Int. Cl. F03D 3/02; F03D 9/00; F03D 80/70; F03D 3/00

(52) U.S. Cl. CPC F03D 3/02; F03D 3/005; F03D 9/002; F03D 80/70

(57) ABSTRACT

A wind power generating apparatus that includes a generator unit having an upper shaft and a lower rotary shaft connected to a rotor, wherein a circumference of the generator unit is supported by an upper portion of a support structure at a specified level, a lifting propeller vertically coupled to an end of the upper rotary shaft via a first coupler, a wind-power fan vertically coupled to an end of the lower rotary shaft via a second coupler, and a support unit coupled to a lower portion of the support structure so as to reversely support summed weights of the rotor, the lifting propeller, and the wind-power fan on a center of rotation of a lower side of the wind-power fan.

### TECHNICAL FIELD

The present invention relates generally to a wind power generating apparatus. More particularly, the present invention relates to a wind power generating apparatus that can be freely installed at any place where a strong wind is present, such as a narrow valley or the like thereby improving power-generation efficiency.

### BACKGROUND ART

As is well known to those skilled in the art, wind has been emerging as a future energy source that is a pollution-free and clean. Wind has many advantages as an energy source, namely, it is abundant, cheap, inexhaustible, widely-dispersed, unlike other energy sources such as oil.

As wind power generation technology has been in development since the early 1990s, wind-power turbine design and wind-energy conversion efficiency have been improved, leading to high economical viability for wind-to-energy conversion.

The wind power generation industry is now a sustainable and rapidly-growing industry. In addition, it is certain that wind power will comprise a great portion of future energy sources, and it is also expected that wind power will change the global energy field and the global economy itself.

Such rapid growth in wind power generation has enabled many countries in the world to have wind-power generation systems. Much research on wind power generation has been conducted, primarily in countries such as Denmark, Germany, Spain, and the USA where wind power generation was first realized, and now in second mover countries such as South Korea, England, France, Brazil, and China.

For example, a high-efficiency vertical-type wind-power generating apparatus disclosed in Korean Patent No. 541231 includes: a variable wind-collecting cover serving to protect an exterior of a rotor and to collect wind; a pair of horizontally symmetric upper variable rotors installed in the variable wind-collecting cover, the rotors having an inertial weight on an outer surface thereof with which a rotary shaft is not brought into contact with, the rotors being coupled to the rotary shaft with a plurality of diaphragms forming an air passage, and a portion of which forms an open rotor opening according to wind speed: and a pair of horizontally symmetric lower variable rotors coupled to lower portions of the upper variable rotors, and whole rotor blades are disposed at a right angle.

However, such a conventional vertical-type wind power generating apparatus has a problem in that, although the variable wind-collecting cover and other elements described above are provided for improved efficiency, in spite of small size, the structure is relatively complex and operation varies according to wind speed. Accordingly, the apparatus has an unstable form, which makes it difficult to improve wind-power generation efficiency while ensuring a secure structure.

Therefore, there is a need to provide a wind power generating apparatus and technique that is capable of generating electricity irrespective of the direction and strength of wind, improving wind-power generation efficiency without requiring a large structure, and applying a new, efficient structure while solving problems with the related art.

### DISCLOSURE

### Technical Problem

Accordingly, the present invention has been made keeping in mind the above problems occurring in the related art, and an object of the present invention is to provide a wind power generating apparatus capable of minimizing friction resistance of rotation to increase rotary force of a rotor, thereby improving wind-power generation efficiency.

### Technical Solution

In order to accomplish the above object, in an embodiment, the present invention provides a wind power generating apparatus including: a generator unit wherein a circumference of which is supported by an upper portion of a support structure at a specified level by means of a plurality of mounting brackets and having upper and lower rotary shafts connected to a rotor; a lifting propeller vertically coupled to an end of the upper rotary shaft of the generator unit via a first coupler so as to be driven by the upper rotary shaft; a wind-power fan vertically coupled to an end of the lower rotary shaft of the generator unit via a second coupler so as to rotate the lower rotary shaft; and a support unit coupled to a lower portion of the support structure at a specified level by means of a mounting bracket in a leverage-support manner such that a center of rotation of the wind-power fan is supported so as to reversely apply a force proportional to the summed weights of the rotor, the lifting propeller, and the wind-power fan.

In an embodiment, the first and second couplers may respectively include a plurality of plate bodies vertically disposed on one another, and a set of bolts and nuts circumferentially disposed at regular intervals on planar portions of the plate bodies and coupled together through the planar portions.

In an embodiment, the wind-power fan may include a rotary shaft vertically fixed to a center of a lower surface of the plate body of the second coupler, a plurality of vanes fixed to a lower end of the rotary shaft in such a way as to be circumferentially evenly positioned at a specified angle so as to be rotated in one direction against a wind blowing from a lateral side, and a connection block protruding from a center of rotation on a lower end of the vanes and having a wedge groove with a specified depth through which one side of the support unit is safely inserted.

In an embodiment, the support unit may include a support stage having a wedge portion on one side thereof and horizontally hinged about a hinge pin at an upper end of the mounting bracket such that the wedge portion is inserted into the wedge groove of the connection block of the wind-power fan, and a weight body disposed on the other side of the support stage so as to load the other side of the support stage such that a force proportional to the summed weights of the rotor, the lifting propeller, and wind-power fan applied to one side of the support stage is applied.

### Advantageous Effects

As described above, the wind power generating apparatus according to the present invention can support summed weights of the rotor, the lifting propeller, and the wind-power fan, and can draw up the rotor and the wind-power fan using a force (a lifting force) generated upon rotation of the lifting propeller so as to minimize friction resistance of rotation, thereby providing the effects of substantially increasing both a rotation force of the rotor and wind power generation efficiency.

### DESCRIPTION OF DRAWINGS

FIG. 1 is an exploded perspective view illustrating a wind power generating apparatus according to an embodiment of the present invention; and

FIG. 2 is a view illustrating an assembly of the wind power generating apparatus according to the embodiment.

### MODE FOR INVENTION

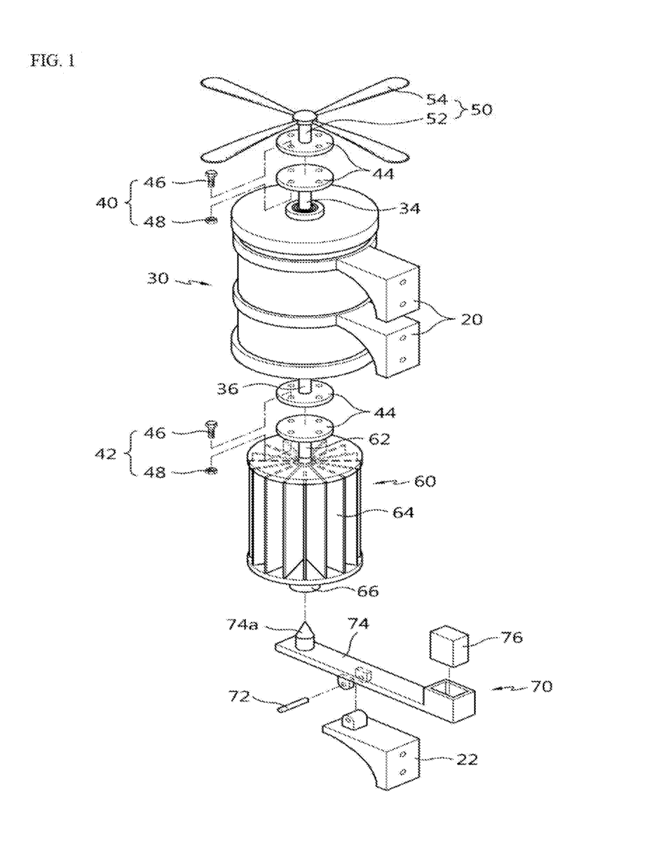

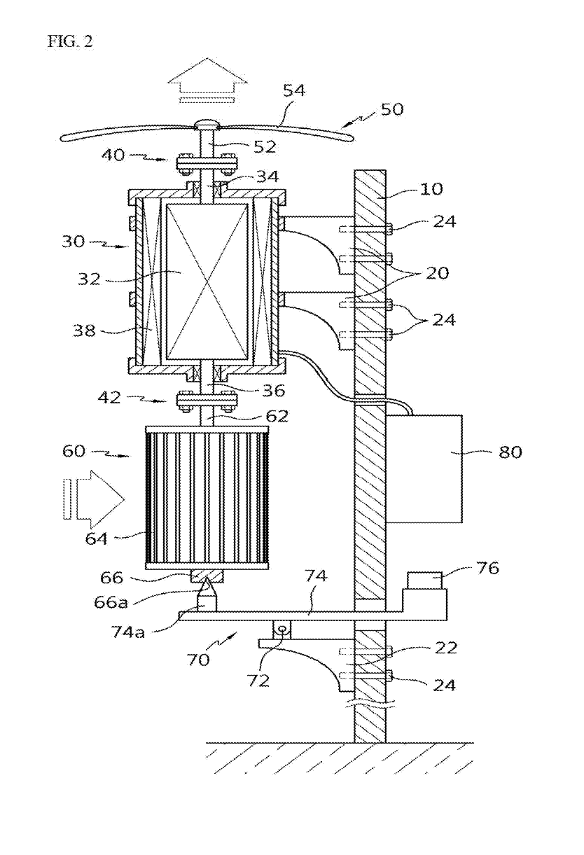

Hereinafter, an embodiment of the present invention will be described in detail with reference to FIGS. 1 and 2.

As illustrated in FIGS. 1 and 2, a wind power generating apparatus according to an embodiment of the present invention includes a generator unit 30 a circumference of which is supported by an upper portion of a support structure 10 at a specified level by means of a plurality of mounting brackets 20 and having upper and lower rotary shafts 34 and 36 connected to a rotor 32; a lifting propeller 50 vertically coupled to an end of the upper rotary shaft 34 of the generator unit 30 via a first coupler 40 so as to be driven by the upper rotary shaft 34; a wind-power fan 60 vertically coupled to an end of the lower rotary shaft 36 of the generator unit 30 via a second coupler 42 so as to rotate the lower rotary shaft 36; and a support unit 70 coupled to a lower portion of the support structure 10 at a specified level by means of a mounting bracket 22 in a leverage-support manner so as to support summed weights of the rotor 32, the lifting propeller 50, and the wind-power fan 60 on a center of rotation of a lower side of the wind-power fan 60.

Here, the rotor 32 may preferably be arranged such that the rotor is disposed coaxially with a stator 38 installed on an inner surface of the casing of the generator unit 30, and the upper and lower rotary shafts 34 and 36 are rotatably supported by upper and lower portions of the casing of the generator unit 30 by means of bearings.

The first and second couplers 40 and 42 respectively include a plurality of plate bodies 44 vertically disposed on one another, and a set of bolts 46 and nuts 48 circumferentially disposed at regular intervals on planar portions of the plate bodies 44 and coupled together through the planar portions.

The lifting propeller 50 includes a stationary shaft 52 vertically fixed to a center of an upper surface of the plate body 44 of the first coupler 40, and a plurality of blades 54 horizontally fixed to a circumference of an upper end of the rotary shaft 52 at regular intervals.

The wind-power fan 60 includes a rotary shaft 62 vertically fixed to a center of a lower surface of the plate body 44 of the second coupler 42, a plurality of vanes 64 fixed to a lower end of the rotary shaft 62 in such a way as to be circumferentially evenly positioned at a specified angle so as to be rotated in one direction against a wind blowing from a lateral side, and a connection block 66 protruding from a center of rotation on a lower end of the vanes 64 and having a wedge groove 66a with a specified depth through which one side of the support unit is safely inserted.

The support unit 70 includes a support stage 74 having a wedge portion 74a on one side thereof and horizontally hinged about a hinge pin 72 at an upper end of the mounting bracket 22 such that the wedge portion is inserted into the wedge groove 66a of the connection block 66 of the wind-power fan 60, and a weight body 76 disposed on the other side of the support stage 74 so as to load the other side of the support stage 74 to support summed weights of the rotor 32, the lifting propeller 50, and wind-power fan 60 applied to one side of the support stage 74.

Unexplained reference numerals 24 and 80 respectively indicate bolts for fastening the mounting brackets 21 and 22 to the support structure 10 and a battery storing electricity generated by the generator unit 30.

The operation and effect of the wind power generating apparatus according to the present invention will now be described.

After the lifting propeller 50 and the wind-power fan 60 are connected to the upper and lower rotary shafts 34 and 36 of the rotor 32 of the generator unit 30 along a vertical axis, the assembly is supported by the mounting brackets 20 at the upper portion of the support structure 10 so as to be suspended from the mounting bracket in a cantilever manner, and at the same time, the assembly is supported by the mounting bracket 22 and the support unit 70 at the lower portion of the support structure 10 in a leverage-support manner such that the center of rotation of the lower side of the wind-power fan 60 is supported so as to reversely apply a force proportional to the summed weights of the rotor 32, the lifting propeller 50, and wind-power fan 60. This enables the assembly to be balanced to maintain a vertical state while minimizing sagging occurring due to self weight of the assembly, thereby increasing the rotation force of the assembly of the rotor 32, the lifting propeller 50 and the wind-power fan 60.

That is, at one side of the support stage 74, the wedge portion 74a supports the lower side of the wind-power fan 60 with a minimum support area by a point contact with the wedge groove 66a of the connection block 66, and at the same time, at the other side of the support stage 74, the weight body 76 operates a support action in a leverage-support manner so as to reversely apply a force proportional to summed weights of the rotor 32, the lifting propeller 50, and the wind-power fan 60, thereby preventing sagging of the generator unit 30 and maintaining a vertical stage of the assembly of the rotor 32, the lifting propeller 50, and the wind-power fan 60 such that the assembly does not lean to one side, thereby minimizing mechanical friction resistance of the assembly. Here, the mechanical friction resistance means a force against rotation applied to the assembly of the rotor 32, the lifting propeller 50, and the wind-power fan 60 due to sagging or leaning of the assembly.

When being affected by winds while the support unit 70 reversely supports the weight of the assembly of the rotor 32, the lifting propeller 50, and the wind-power fan 60, the wind-power fan 60 is rotated at high speed, so that the rotor 32 and the lifting propeller 50 are also rotated at the same direction and speed.

Here, the lifting propeller 50 draws up the rotor 32 using a force (a lifting force) generated upon rotation so as to minimize friction resistance of rotation of the rotor 32 and the wind-power fan 60 occurring due to sagging by self weight, thereby providing the effects of substantially increasing both a rotation force of the rotor 32 and wind power generation efficiency.

Although a preferred embodiment of the present invention has been described, the present invention is not limited thereto. Various change and modifications may be made to the disclosed embodiment without departing from the scope and spirit of the invention, and it should be understood that such changes and modifications belong to the invention as disclosed in the accompanying claims.

### DESCRIPTION OF REFERENCE NUMERALS

10: Support structure
20, 22: Mounting bracket
30: Generator unit
32: Rotor
34: Upper rotary shaft
36: Lower rotary shaft
38: Stator
40: First coupler
42: Second coupler
50: Lifting propeller
60: Wind-power fan
62: Rotary shaft
64: Blade
66: Connection block
66a: Wedge groove
70: Support unit
72: Hinge pin
74: Support stage
74a: Wedge portion
76: Weight body

1. A wind power generating apparatus comprising:
a generator unit having an upper shaft and a lower rotary shaft connected to a rotor, wherein a circumference of the generator unit is supported by an upper portion of a support structure at a specified level by means of a plurality of mounting brackets;
a lifting propeller vertically coupled to an end of the upper rotary shaft of the generator unit via a first coupler so as to be driven by the upper rotary shaft;
a wind-power fan vertically coupled to an end of the lower rotary shaft of the generator unit via a second coupler so as to rotate the lower rotary shaft; and
a support unit coupled to a lower portion of the support structure at a specified level by means of a mounting bracket in a leverage-support manner such that a center of rotation of the wind-power fan is supported so as to reversely apply a force proportional to the summed weights of the rotor, the lifting propeller, and the wind-power fan.

2. The wind power generating apparatus as set forth in claim 1, wherein the first and second couplers respectively include:
a plurality of plate bodies vertically disposed on one another, and
a set of bolts and nuts circumferentially disposed at regular intervals on planar portions of the plate bodies and coupled together through the planar portions.

3. The wind power generating apparatus as set forth in claim 1, wherein the wind-power fan includes:
a rotary shaft vertically fixed to a center of a lower surface of the plate body of the second coupler;
a plurality of vanes fixed to a lower end of the rotary shaft in such a way as to be circumferentially evenly positioned at a specified angle so as to be rotated in one direction against a wind blowing from a lateral side; and
a connection block protruding from a center of rotation on a lower end of the vanes and having a wedge groove with a specified depth through which one side of the support unit is safely inserted.

4. The wind power generating apparatus as set forth in claim 1, wherein the support unit includes:
a support stage having a wedge portion on one side thereof and horizontally hinged about a hinge pin at an upper end of the mounting bracket such that the wedge portion is inserted into a wedge groove of the connection block of the wind-power fan; and
a weight body disposed on the other side of the support stage so as to load the other side of the support stage such that a force proportional to the summed weights of the rotor, the lifting propeller, and wind-power fan applied to one side of the support stage is applied.
